(19) United States
(12) Patent Application Publication
(10) Pub. No.: US 2014/0287297 A1
(43) Pub. Date: Sep. 25, 2014

(54) Battery Cell, Battery and Motor Vehicle

(71) Applicants: ROBERT BOSCH GmbH, Stuttgart (DE); Samsung SDI Co., Ltd., Yongin-si, Gyeonggi-do (KR)

(72) Inventors: Alexander Reitzle, Neu-Ulm (DE); Joachim Fetzer, Bad-Ditzenbach (DE)

(21) Appl. No.: 14/353,411

(22) PCT Filed: Sep. 20, 2012
(86) PCT No.: PCT/EP2012/068514

§ 371 Date: Apr. 22, 2014

(30) Foreign Application Priority Data
Nov. 10, 2011 (DE) 10 2011 086 050.9

(51) Int. Cl. H01M 2/02

(52) U.S. Cl. CPC H01M 2/024
USPC 429/163

(57) ABSTRACT

A battery cell includes a battery cell housing that is patterned in a form of a folding structure. In another embodiment, a battery cell includes a battery cell housing that is patterned in a form of a sandwich construction which comprises an intermediate layer and two cover layers. In a further embodiment, a battery cell includes a battery cell housing that is patterned in a form of an inversion structure. An exemplary battery includes a plurality of such battery cells, and can be comprised by a motor vehicle.

The present invention relates to a battery cell having a battery cell casing, a battery that comprises a plurality of battery cells of this type, and a motor vehicle that comprises the battery.

### PRIOR ART

Batteries are being used ever more frequently as mobile energy sources for the drive in automobiles, especially since the development of lithium ion secondary cells that in comparison to older technologies, such as by way of example lead-acid storage batteries, provide a high energy or rather a high power density. The new battery technologies were developed for use in electronic devices, such as for example video cameras or mobile telephones and have quite different requirements with regard to environmental pollution than batteries that were developed for the automotive industry. However, the same degree of consideration is given to one subject for the two application areas. Thus, the batteries must not be mechanically damaged during accidents, the casing or rather in the case of the motor vehicle the chassis must absorb all forces and loads in order to prevent the battery cells from being damaged inside. If the battery cells are indeed mechanically damaged in this way, then it is generally not possible to control the subsequent reactions since the cells are not designed for such an event. Especially when used in vehicles, the energy storage device must meet the highest safety standards in order not to pose a risk particularly in the event of a collision.

Individual battery cells are combined to form battery modules and these in turn are combined to form batteries. FIG. 1 illustrates how individual battery cells 10 can be connected in parallel or in series to form battery modules 12 and then to form batteries 14. As a result, a battery module 12 and accordingly a battery 14 are by definition produced from at least two battery cells 10, wherein the terms ‘battery’ and ‘battery module’ are frequently used synonymously.

EP 2 172 994 A1 discloses a battery module that comprises a multiplicity of battery cells whose first ends (comprising the battery terminals) are held in a first cover that comprises cap-shaped received devices. Cell connectors are integrated in the cap-shaped receiving devices in order to connect the terminals of the battery cells in an electrically conductive manner. The second ends of the battery cells are held in a second cover, wherein the second cover encloses the ends in a gas tight manner so that this is used as a degassing system. In the event of battery gases escaping from the battery cells, by way of example during an overload situation or a defect, said gases are collected by the second cover and by way of example discharged by way of a tube out of the battery module and accordingly out of the vehicle.

WO 2010/111647 A2 likewise describes a battery module that comprises a multiplicity of battery cells and a degassing system, wherein each side of the battery cells, from which battery gas can escape, is coupled to the degassing system. However, in contrast to EP 2 172 994 A1, in this case two opposite lying sides of the degassing system can be coupled to battery cells.

However, in the case of a vehicle accident, it is not only necessary to ensure that escaping battery gases are safely directed out of the vehicle, but rather it is also desirable to prevent critical damage to the battery cells.

Three different battery cell types are used in automobiles; cylindrical cells, prismatic cells and cells that have soft casings (pouch cells). All cells have in common that they can deform under the effects of forces. However, one problem of this deformation is that generally it is not possible to predict at which site on the cell the deformation begins and how the deformation continues to spread along the casing. In the worst case, this deformation commences at sites on the cells at which as a result of the deformation the internal structure of the cell is damaged to such an extent or destroyed that the subsequent reactions can be extremely severe, by way of example in the form of an explosion.

### DISCLOSURE OF THE INVENTION

A battery cell that comprises a battery cell casing is provided in accordance with a first embodiment of the invention. The battery cell casing has a characterizing feature of being constructed in the form of a folding structure. This folding structure is generally embodied from repeating folding segments and can be achieved in the form of a micro-structuring of the battery cell casing. Micro-structures of this type can be stamped or created using a laser by way of example into the battery cell casing.

The battery cell in accordance with the invention and in accordance with the first embodiment has the advantage that, in the event of a force occurring, deformation commences at a predefined site and then also continues in a controlled manner at the battery cell casing. In the case of folding structures, so-called plastically deformable hinges are bent by means of the influence of force, as a result of which the bending front runs uniformly through the structure that is to be bent. The influence of force causes the individual micro-structures to fold together at the plastically deformable hinges, the dimensions of the battery cell casing that has been folded together can be determined accurately in advance by means of structures of this type. In addition, a part of the kinetic energy that is to be absorbed in the case of vehicle collisions is not only absorbed by the chassis of the vehicle but rather is also absorbed by the mechanical structure of the battery cell casing as a result of the micro-mechanical structuring. Although, the cell becomes unusable in its function as an energy storage device as a result, it is however possible to control the subsequent reactions (e.g. internal short circuit, opening of the cells, fire) of the cells. It is possible to accurately predict the subsequent reactions since the mechanical behavior can be controlled in a precise manner as the battery cells are deformed.

As a consequence, the safety of the battery cells increases significantly in comparison to the current prior art since, by virtue of being able to predict the mechanical deformation of the battery cells, the internal structure of the cells can be designed so that subsequent reactions that are associated with a high level of risk can no longer occur. Furthermore, the micro-structures that are introduced into the battery cell casing have the advantage that they can increase the strength of the battery cell casing, as a result of which any possible deformation only commences under the influence of greater forces than in the case of cells that have hitherto been used.

In accordance with one advantageous embodiment of the invention, the folding structure has a structure that is wavy in the cross section with straight connecting pieces. The straight connecting pieces are connected to one another by way of small rounded or bent transition regions that act as plastically deformable hinges in the presence of a loading. The peak-to-peak value is preferably less than or equal to 2.0 mm, the longitudinal extension of a folding segment is preferably less than or equal to 1.5 mm, wherein this value depends upon the number of desired folds.

Furthermore, it is preferred that the folding structure has a wavy structure throughout the cross section with bends that are less than 180°. The peak-to-peak value is preferably less than or equal to 2.0 mm, the longitudinal extension of a folding segment is preferably less than or equal to 1.5 mm, wherein this value depends upon the number of desired folds. The wavy structure throughout the cross section can preferably be embodied in a sinusoidal manner. Furthermore, it is preferred that the bend can also be equal to 180°.

Furthermore, it is preferred that the folding structure has a wavy structure that is intertwined in the cross section with bends that are greater than 180°. The peak-to-peak value is preferably less than or equal to 2.0 mm, the longitudinal extension of a folding segment is preferably less than or equal to 1.5 mm, wherein this value depends upon the number of desired folds.

In accordance with a second embodiment of the invention, a further battery cell comprising a battery cell casing is provided. The battery cell casing has a characterizing feature of being constructed in the form of a sandwich construction comprising an intermediate layer and two cover layers. Consequently, the battery cell casing is not embodied as one layer but rather with multiple metal layers wherein the individual metal layers are connected one to another with a stabilizing structure.

The battery cell in accordance with the invention in accordance with the second embodiment has the advantage that in the case of pressure being exerted on these structures energy can be absorbed by means of deformation without the interior of the battery cells being damaged. As a consequence, only the empty spaces of the intermediate layer are squashed. The influence of force, by way of example during a collision, causes the intermediate layer to deform, as a consequence of which said intermediate layer assists with the absorption of energy.

It is preferred that the intermediate layer of the sandwich construction has a honeycomb structure. This honeycomb structure forms a multiplicity of hexagons arranged in rows one adjacent to the other similar to a bee honeycomb.

Furthermore, it is preferred that the intermediate layer of the sandwich construction is constructed from tubes that are arranged in a purely parallel manner with respect to one another and are connected to one another. In an advantageous manner, the tubes are arranged so that in the case of a predetermined space and predetermined tube diameter there is space for as many tubes as possible. This means that the tubes nestle one inside the other in rows, i.e. one row is arranged offset with respect to the next row in the row direction by the value of half the tube diameter.

In accordance with a third embodiment of the invention, a further battery cell comprising a battery cell casing is provided. The battery cell casing has a characterizing feature of being constructed in the form of a structure that inverts under the influence of force. Inverting structures of this type comprise by way of example a hollow body that can be deformed for receiving kinetic energy, and a plunger that causes this deformation. During the deformation, the plunger pushes into the hollow body, following which the walls of the hollow body invert and roll up. Consequently the battery cell casing is not embodied as one layer but rather by a multiplicity of structures that invert under the influence of force and that are arranged in rows one adjacent to the another.

The battery cell in accordance with the invention in accordance with the third embodiment has the advantage that, in dependence upon the radius of the inversion of the inverted wall, soft or hard structures can be produced that require different magnitudes of energy to deform.

Moreover, it is preferred that the battery cells of the first, second or third embodiment of the invention are lithium ion secondary cells. The use of lithium ion technology renders it is possible to achieve particularly high energy storage densities and this leads to further advantages especially in the field of electro mobility.

Suitable materials for the battery cell casing are by way of example metals, in particular aluminum and steel.

Furthermore, a battery is provided that comprises a multiplicity of battery cells in accordance with the invention.

Moreover, a motor vehicle comprising the battery in accordance with the invention is provided, wherein the battery is generally provided for supplying energy to an electrical drive system of the vehicle.

Advantageous embodiments of the invention are disclosed in the subordinate claims or are evident in the description.

### DRAWINGS

Exemplary embodiments of the invention are explained in detail with reference to the drawings and the description hereinunder. In which:

FIG. 1 illustrates an interconnection of battery cells (prior art),

FIGS. 2 to 4 illustrate folding structures,

FIGS. 5 to 7 illustrate an intermediate layer of a honeycomb structure and sandwich constructions,

FIGS. 8 to 10 illustrate an intermediate layer of a tube structure and sandwich constructions, and

FIGS. 11 and 12 illustrate a structure that inverts under the influence of force.

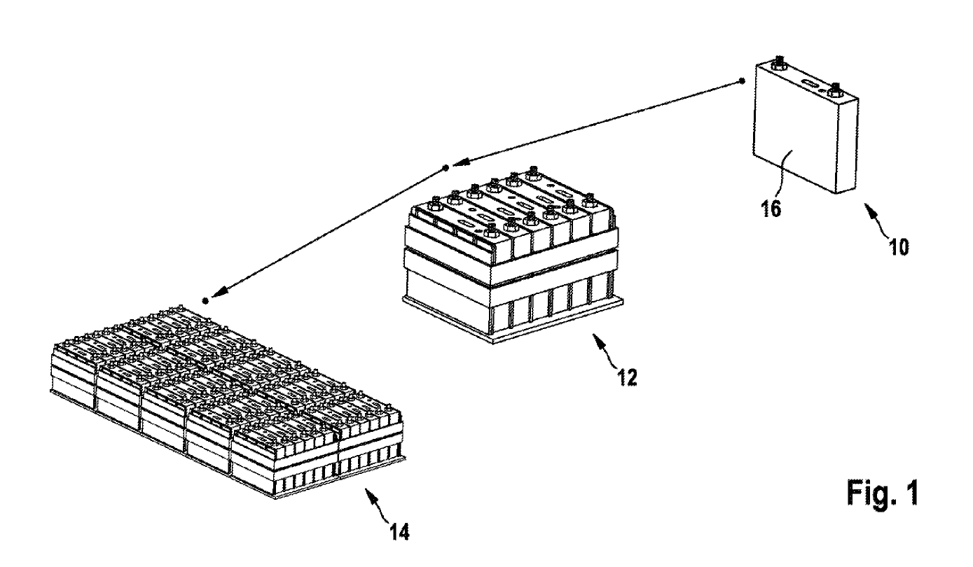

Reference has already been made to FIG. 1 for the purpose of explaining the prior art.

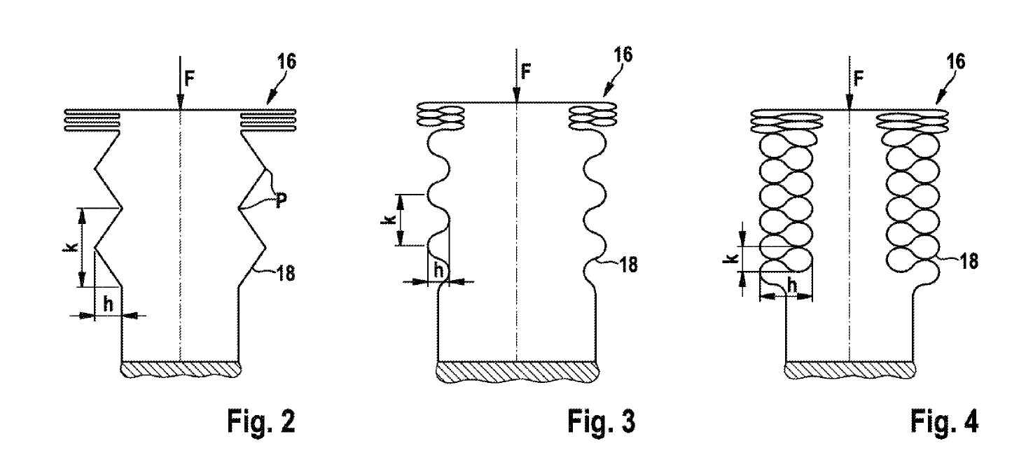

FIGS. 2, 3 and 4 illustrate in schematic illustrations three different folding structures in accordance with the invention 18 of a battery cell casing 16, which can be embodied by way of example, as illustrated, in a rotationally symmetrical manner. The folding structures 18 that are illustrated in the middle region of the battery cell casing 16 are illustrated in an exaggerated manner for the sake of improved clarity, wherein the folding structure 18 that has folded up under the influence of a force F is illustrated in the upper region of the battery cell casing 16. The folding structure 18 can either, as illustrated, cover only one part of the battery cell casing 16 or also cover the entire peripheral surface of the battery cell casing 16. If a force F is applied to the battery cell casing 16, the battery cell casing 16 folds together in a predefined manner as a result of the folding structure 18, as a result of which the destruction of the internal life of the battery cell is predictable.

FIG. 2 illustrates a folding structure 18 that has in the cross section a wavy structure with straight connecting pieces. The peak-to-peak value h is preferably less than or equal to 2.0 mm, the longitudinal extension k of a folding segment is preferably less than or equal to 1.5 mm, wherein this value depends upon the number of desired folds. As the folding structure 18 folds up, the sites P function as plastically deformable hinges and folded structures with bend radii of approx. 180° are produced after the deformation.

FIG. 3 illustrates a folded structure 18 that has in the cross section a continuous wavy structure. The peak-to-peak value h is preferably less than or equal to 2.0 mm, the longitudinal extension k of a folding segment is preferably less than or equal to 1.5 mm, wherein this value depends upon the number of desired folds. Bend radii that are greater than 180° are formed during the folding process.

FIG. 4 illustrates a folding structure 18 that has in the cross section an intertwined wavy structure. The peak-to-peak value h is preferably less than or equal to 2.0 mm, the longitudinal extension k of a folding segment is preferably less than or equal to 1.5 mm, wherein this value depends upon the number of desired folds. Bend radii that are greater than 180° are formed during the folding process.

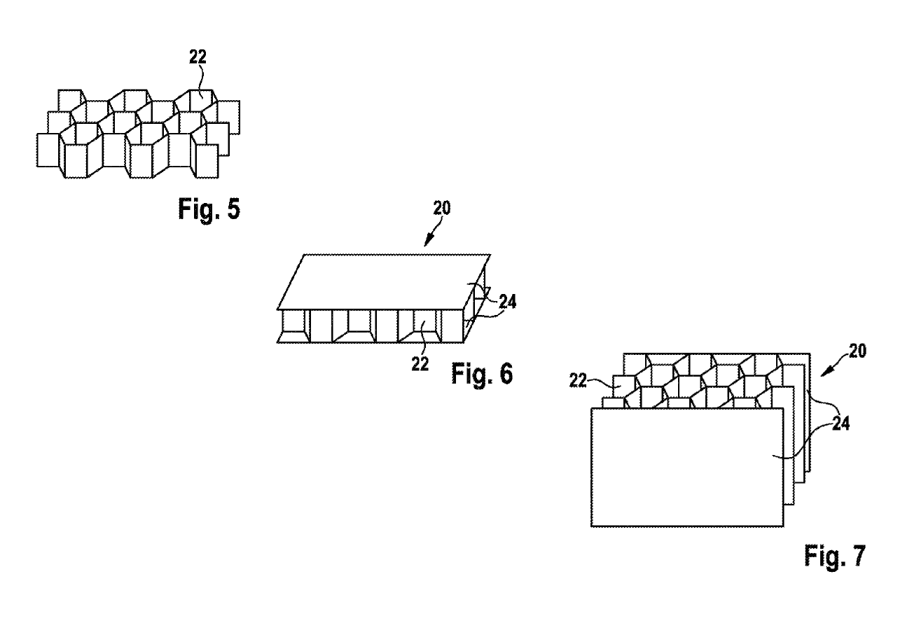

FIG. 5 illustrates an intermediate layer 22 of a sandwich construction 20 in a honeycomb form.

FIG. 6 illustrates a sandwich construction 20 comprising an intermediate layer 22 and two cover layers 24, wherein the cover layers 24 are arranged so that they close the openings of the honeycombs. In accordance with the invention, this sandwich construction 20 is used as material for the battery cell casing 16. As the sandwich construction 20 is loaded with a force that is exerted in the perpendicular direction on the surface extension of the sandwich construction 20, the intermediate layer 22 collapses and by means of deformation absorbs energy without the inside of the battery cell becoming damaged.

FIG. 7 likewise illustrates a sandwich construction comprising an intermediate layer 22 and two cover layers 24, wherein the cover layers 24 are arranged along the peripheral surfaces of the honeycombs. As the sandwich construction 20 is loaded with a force that is exerted in the perpendicular direction on the surface extension of the sandwich construction 20, the intermediate layer 22 collapses and by means of deformation absorbs kinetic energy. In addition, a force component is produced that is perpendicular to the applied force F and perpendicular to the axes of the individual hexagons. This force component provides further possibilities for absorbing energy.

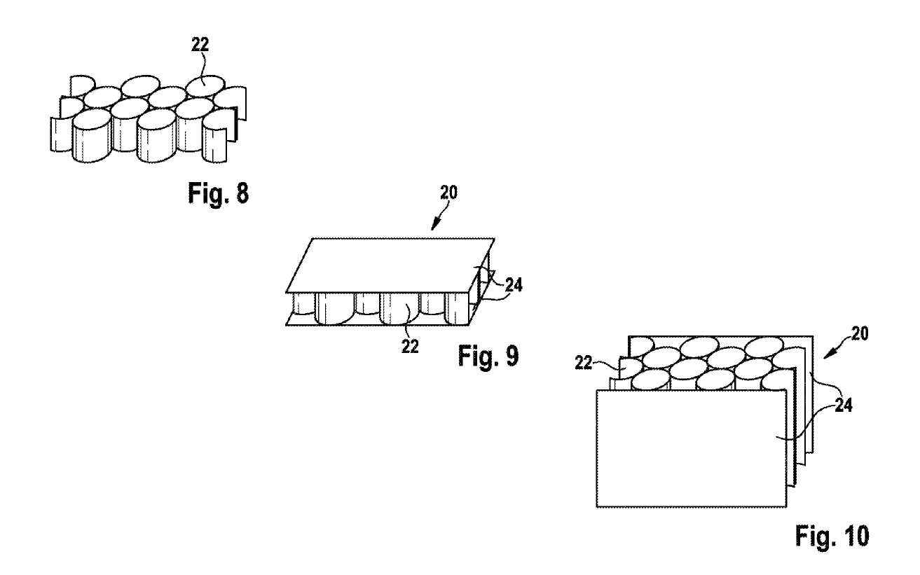

FIG. 8 illustrates a further intermediate layer 22 of a sandwich construction 20. This is not embodied in a honeycomb form on this occasion but rather comprises a multiplicity of tubes. The tubes can, as illustrated, be arranged in rows in a straight line one adjacent to the other and each row that is adjacent to the next row is offset in the longitudinal direction of the row by the value of half the tube diameter. The individual tubes can be connected to one another in order to achieve greater stability.

Similar considerations to those with regard to FIGS. 3b and 3c apply with regard to FIGS. 9 and 10 comprising an intermediate layer 22 of a multiplicity of tubes.

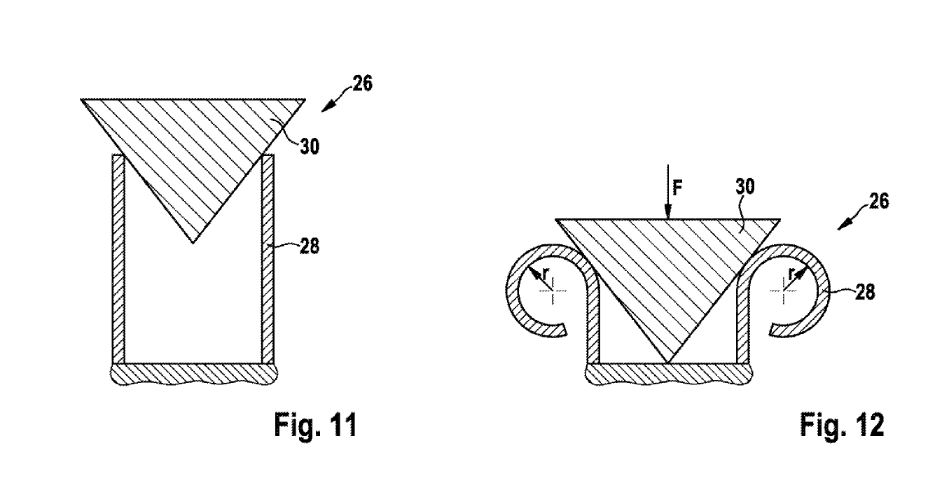

FIG. 11 illustrates an inverting structure 26 in the non-deformed state. This structure comprises a hollow body 28, by way of example a hollow cylinder that has a square cross section, and a plunger 30 that is tailored to suit said hollow cylinder, by way of example said plunger is a pyramid that has a square base area. As a result of providing a multiplicity of structures of this type on the battery cell casing 16, the battery cell casing 16 can absorb a part of the kinetic energy that is to be dissipated during a vehicle collision.

FIG. 12 illustrates the inverting structure in FIG. 5a after it has been deformed under the influence of a force F. The plunger 30 penetrates into the hollow body 28, following which the hollow body 28 tears along its corners and bends over at the chamfered plunger surfaces, as a consequence of which the walls of the hollow body 28 roll up with the radius of inversion r. In dependence upon the radius of inversion r, soft or hard structures can be produced that require different magnitudes of energy to deform.

1. A battery cell comprising a battery cell casing, wherein the battery cell casing is constructed in the form of includes a folding structure.

2. The battery cell as claimed in claim 1, wherein the folding structure has, in a cross section, a wavy structure with straight connecting pieces.

3. The battery cell as claimed in claim 1, wherein the folding structure has, in the a cross section, a continuous wavy structure with bends that are less than 180°.

4. The battery cell as claimed in claim 1, wherein the folding structure has, in the a cross section, an intertwined wavy structure with bends that are greater than 180°.

5. A battery cell comprising a battery cell casing, wherein the battery cell casing includes a sandwich structure that comprises an intermediate layer and two cover layers.

6. The battery cell as claimed in claim 5, wherein the intermediate layer of the sandwich structure has a honeycomb structure.

7. The battery cell as claimed in claim 5, wherein the intermediate layer of the sandwich structure is formed from tubes that are positioned in a parallel manner with respect to one another and are connected to one another.

8. A battery cell comprising a battery cell casing, wherein the battery cell casing is constructed in the form of an inverting structure.

9. The battery cell as claimed in claim 1, wherein the battery cell is one of a plurality of battery cells comprised by a battery.

10. The battery cell as claimed in claim 9, wherein the battery is comprised by a motor vehicle.
